(19) United States
(12) Patent Application Publication
(10) Pub. No.: US 2025/0221515 A1
(43) Pub. Date: Jul. 10, 2025

(54) Cosmetology Training Manikin Securing Apparatus With A Portable Workstation

(71) Applicant: Sharon L Johnson, Port Saint Lucie, FL (US)

(72) Inventor: Sharon L Johnson, Port Saint Lucie, FL (US)

(21) Appl. No.: 18/406,247

(22) Filed: Jan. 8, 2024

(51) Int. Cl. A45D 44/14; F16M 11/04; F16M 11/14

(52) U.S. Cl. CPC A45D 44/14; F16M 11/046; F16M 11/14

(57) ABSTRACT

An embodiment of a cosmetology training manikin securing apparatus (CTMSD) includes a generally circular brace member (CBM) for securing a manikin to a workstation. The CBM includes a first section hingedly attached to a second section, and a rib disposed on an inner perimeter of the CBM. The first section, including multiple teeth, extends along a quarter length of the CBM's circumference. Each tooth is oriented for slotting into a slot in the second section of the CBM to tightly secure the manikin's head to the CBM. The second section extends along three quarters length of the CBM's circumference. Another embodiment of the CTMSD includes a brace with first and second ring members and a circular bearing disposed therebetween. The second ring member includes multiple spring-loaded retention members disposed on an inner section of the second ring member to securely hold the manikin's neck.

### BACKGROUND

The apparatus disclosed herein, in general, relates cosmetology training. More particularly, the apparatus disclosed herein relates to an apparatus for securing a manikin's head to a portable workstation for grooming, coloring, and/or cutting the manikin's hair. Most cosmetology schools utilize manikins, known as training manikins, each having a neck, a head, and hair. The bottom portion of the manikin's neck is typically flat to ensure that the manikin may rest on a table, a desk, or another flat surface, and remain in an upright orientation. In this upright orientation, a wig may be donned on the head of the manikin and the hair of the wig may be groomed and/or cut by a hairdresser, a hair stylist, a beautician, a cosmetologist, or a trainee, hereinafter referred to as a “user”. Furthermore, the manikin may be used for eye and other face cosmetic application training. The manikin may also be tilted or positioned in a horizontal orientation for shampoo training. A user may sometimes hold the manikin's head in the horizontal orientation or in a tilted orientation while practicing shampoo and rinse exercises. However, it is inconvenient for the user to hold the manikin's head while the manikin's head is shampooed. Hence, there is a long-felt yet unresolved need for an apparatus for securing the manikin's head in a desired orientation, for example, in a horizontal orientation for shampooing and/or rinsing, in an upright or vertical position for cutting hair, etc.

Moreover, the user may also need to rotate the manikin's head as it may be inconvenient and/or tiring for the user to move around a fixed manikin's head. For example, while making a wig, the user may rotate the manikin's head about a vertical axis to access the front, rear, and sides of the wig placed on the manikin's head. Hence, there is a long-felt yet unresolved need for an apparatus that allows a manikin's head to be rotated about a desired axis.

Furthermore, for better reach, the user may wish to adjust the height of an apparatus on which the manikin's head is mounted. For example, for eye and other face cosmetic application training, the user may wish to increase the height of the apparatus on which the manikin's head is mounted to bring the manikin's head in-line with the user's face. Hence, there is a long-felt yet unresolved need for an apparatus that allows a user to adjust the height of the apparatus on which the manikin's head is mounted to provide a convenient access to the manikin's head.

### SUMMARY OF THE INVENTION

This summary is provided to introduce a selection of concepts in a simplified form that are further disclosed in the detailed description of the invention. This summary is not intended to determine the scope of the claimed subject matter.

The cosmetology training manikin securing apparatus disclosed herein addresses the above-recited need for securing a manikin's head in a desired orientation, for example, in a horizontal orientation for shampooing and/or rinsing, in an upright or vertical position for cutting hair, etc. Furthermore, the cosmetology training manikin securing apparatus disclosed herein addresses the above-recited need for allowing a manikin's head to be rotated about a desired axis. Furthermore, the cosmetology training manikin securing apparatus disclosed herein addresses the above-recited need for allowing a user, for example, a beautician, to adjust height of the apparatus on which the manikin's head is mounted to provide a convenient access to the manikin's head.

In a first embodiment, the cosmetology training manikin securing apparatus for securing a manikin to a workstation comprises a generally circular brace member configured to secure the manikin to the workstation. The generally circular brace member comprises a first section, a second section, and a rib. The first section extends along a quarter length of a circumference of the generally circular brace member. The first section comprises multiple teeth, where each tooth is oriented for slotting into a slot in the second section of the generally circular brace member. In an embodiment, a cross-section of each tooth in the first section of the generally circular brace member is in the shape of an obtuse triangle. A longer side of each tooth slopes gradually upwards from the first end of the first section towards a second end of the first section. The second section comprises a first end and a second end. The first end of the second section is hingedly attached to a second end of the first section. The second section extends along three quarters length of the circumference of the generally circular brace member. The slot is disposed at the second end of the second section. The rib is disposed on an inner perimeter of the generally circular brace member. The rib extends from a first end of the first section and terminates proximal to the second end of the second section behind the slot. The generally circular brace member is configured to be tightly wrapped around a neck of the manikin. One of the teeth that is most proximal to the slot is slotted into the slot to secure the manikin to the generally circular brace member.

In an embodiment, the generally circular brace member is further configured to be secured to the workstation. The workstation comprises a first frame member attached to a second frame member. Furthermore, a first channel is attached to the first frame member and a second channel is attached to the second frame member.

In an embodiment, the cosmetology training manikin securing apparatus further comprises a first holder and a second holder configured to slidably engage with the generally circular brace member. The first holder and the second holder are configured to secure the generally circular brace member to a height adjustment member. The first holder is rotatably attached to a first horizontal member and the second holder is rotatably attached to a second horizontal member. Furthermore, each of the first holder and the second holder comprises a threaded knob configured to secure the first holder and the second holder to the first horizontal member and the second horizontal member, respectively. In an embodiment, the height adjustment member comprises a Y-shaped member comprising a shaft, a first prong, and a second prong. The first horizontal member is attached to the first prong and the second horizontal member is attached to the second prong.

The cosmetology training manikin securing apparatus further comprises a third horizontal member and a shaft collar. The third horizontal member is configured to slidably secure the height adjustment member to the workstation. The shaft collar is disposed at a substantially mid-section of the third horizontal member. The shaft collar is configured to slidably accommodate the shaft of the Y-shaped member and secure the Y-shaped member at a predetermined height above the workstation in an upright position. In an embodiment, the cosmetology training manikin securing apparatus further comprises a first roller wheel set and a second roller wheel set. The first roller wheel set is suspended underneath a first end of the third horizontal member. The first roller wheel set is rollably accommodated within the first channel of the workstation. The second roller wheel set is suspended underneath a second end of the third horizontal member. The second roller wheel set is rollably accommodated within the second channel of the workstation. The first channel is secured to the first frame member of the workstation and the second channel is secured to the second frame member of the workstation. In an embodiment, each of the first frame member and the second frame member of the workstation comprises multiple channels configured to slidably accommodate one or more of a shampoo sink, a basin, a bowl, a bucket, and an accessory tray. In an embodiment, the workstation comprises caster wheels attached to the first frame member and the second frame member of the workstation.

In a second embodiment, the cosmetology training manikin securing apparatus for securing a manikin to a workstation comprises a brace configured to secure the manikin to the workstation. The brace comprises a first ring member, a second ring member, and a circular bearing. The first ring member comprises a first wall and a second wall. The first wall is disposed on an upper side of an inner section of the first ring member. The second wall is disposed on a lower side of the inner section of the first ring member. The second ring member comprises a first wall and a second wall. The first wall of the second ring member is disposed on an upper side of an outer section of the second ring member. The second wall of the second ring member is disposed on a lower side of the outer section of the second ring member. The second ring member further comprises multiple spring-loaded retention members disposed on an inner section of the second ring member. The spring- loaded retention members are configured to securely hold a neck of the manikin when the neck is inserted into the second ring member. The circular bearing is disposed between the first ring member and the second ring member. The second embodiment of the cosmetology training manikin securing apparatus further comprises a first swivel ball head and a second swivel ball head. The first swivel ball head is attached to an outer section of the first ring member of the brace. The second swivel ball head is attached to the outer section of the first ring member of the brace, diametrically opposite to the first swivel ball head. The brace is further configured to be secured to the workstation through the first swivel ball head and the second swivel ball head.

In an embodiment, the first swivel ball head is rotatably attached to a first horizontal member and the second swivel ball head is rotatably attached to a second horizontal member. Furthermore, each of the first swivel ball head and the second swivel ball head comprises a lever configured to tighten or loosen a swivel movement of a ball located within the first swivel ball head and the second swivel ball head. The lever of each of the first swivel ball head and the second swivel ball head is configured to secure the first swivel ball head and the second swivel ball head to the first horizontal member and the second horizontal member, respectively.

In an embodiment, the first horizontal member and the second horizontal member are configured to secure the brace to a height adjustment member. In an embodiment, the height adjustment member comprises a Y-shaped member comprising a shaft, a first prong, and a second prong. The first horizontal member is attached to the first prong and the second horizontal member is attached to the second prong.

The second embodiment of the cosmetology training manikin securing apparatus further comprises a third horizontal member and a shaft collar. The third horizontal member is configured to slidably secure the height adjustment member to the workstation. The shaft collar is disposed at a substantially mid-section of the third horizontal member. The shaft collar is configured to slidably accommodate the shaft of the Y-shaped member and secure the Y-shaped member at a predetermined height above the workstation in an upright position.

The second embodiment of the cosmetology training manikin securing apparatus further comprises a first roller wheel set and a second roller wheel set. The first roller wheel set is suspended underneath a first end of the third horizontal member. The first roller wheel set is rollably accommodated within the first channel of the workstation. The second roller wheel set is suspended underneath a second end of the third horizontal member. The second roller wheel set is rollably accommodated within the second channel of the workstation. The first channel is secured to the first frame member of the workstation and the second channel is secured to the second frame member of the workstation. In an embodiment, each of the first frame member and the second frame member of the workstation comprises multiple channels configured to slidably accommodate one or more of a shampoo sink, a basin, a bowl, a bucket, and an accessory tray. In an embodiment, the workstation comprises caster wheels attached to the first frame member and the second frame member of the workstation.

These and further features of the cosmetology training manikin securing apparatus will be apparent with reference to the following description and drawings. In the description and drawings, particular embodiments of the cosmetology training manikin securing apparatus have been disclosed in detail as being indicative of some of the ways in which the principles of the cosmetology training manikin securing apparatus may be employed, but the cosmetology training manikin securing apparatus is not limited correspondingly in scope. Rather, the cosmetology training manikin securing apparatus includes all changes, modifications, and equivalents coming within the spirit and terms of the claims.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific components and structures disclosed herein. The description of a component or a structure referenced by a numeral in a drawing is applicable to the description of that component or structure shown by that same numeral in any subsequent drawing herein.

FIG. 1 illustrates a top perspective view of a first embodiment of a cosmetology training manikin securing apparatus comprising a generally circular brace member.

FIG. 2 illustrates a top plan view of the first embodiment of the cosmetology training manikin securing apparatus, showing a first section of the generally circular brace member in an open position with respect to a second section of the generally circular brace member.

FIG. 3 illustrates a top perspective view of the first embodiment of the cosmetology training manikin securing apparatus, showing the first section of the generally circular brace member in a closed position with respect to the second section of the generally circular brace member.

FIG. 4 illustrates a top plan view of the first embodiment of the cosmetology training manikin securing apparatus, showing the first section of the generally circular brace member in the closed position with respect to the second section of the generally circular brace member.

FIG. 5 illustrates a top plan view of the second section of the generally circular brace member.

FIG. 6 illustrates a top plan view of the first section of the generally circular brace member.

FIG. 7 illustrates a cross-sectional view of a single tooth of a plurality of teeth in the first section of the generally circular brace member.

FIG. 8 illustrates a top perspective view of the first embodiment of the cosmetology training manikin securing apparatus comprising a first holder and a second holder slidably engaging the generally circular brace member.

FIG. 9 illustrates a front elevation view of the first embodiment of the cosmetology training manikin securing apparatus comprising the first holder, the second holder, a first horizontal member, and a second horizontal member.

FIG. 10 illustrates a cross-sectional view of the first embodiment of the cosmetology training manikin securing apparatus comprising the first holder, the second holder, the first horizontal member, and the second horizontal member.

FIG. 11 illustrates a front perspective view showing the first embodiment of the cosmetology training manikin securing apparatus secured to a third horizontal member through a height adjustment member, the first horizontal member, and the second horizontal member.

FIG. 12 illustrates another front perspective view showing a shaft of a Y-shaped member of the height adjustment member secured to a shaft collar of the third horizontal member.

FIG. 13 illustrates a front perspective view showing the first embodiment of the cosmetology training manikin securing apparatus attached to a workstation via the first horizontal member, the second horizontal member, the height adjustment member, and the third horizontal member.

FIG. 14 illustrates another front perspective view showing a manikin secured to the first embodiment of the cosmetology training manikin securing apparatus attached to the workstation.

FIG. 15 illustrates an enlarged view showing a first roller wheel set suspended underneath a first end of the third horizontal member.

FIG. 16A illustrates a front perspective view of a shampoo sink configured to be slidably accommodated in the workstation.

FIG. 16B illustrates a top plan view of the shampoo sink shown in FIG. 16A.

FIG. 17 illustrates a top plan view of a second embodiment of the cosmetology training manikin securing apparatus comprising a brace, a first swivel ball head, and a second swivel ball head.

FIG. 18 illustrates a top perspective view of the second embodiment of the cosmetology training manikin securing apparatus, showing an enlarged view of the first swivel ball head.

FIG. 19 illustrates a top perspective view showing a sectional view of the second embodiment of the cosmetology training manikin securing apparatus.

FIG. 20 illustrates an exploded, top perspective view of the second embodiment of the cosmetology training manikin securing apparatus.

FIG. 21 illustrates a front perspective view showing the second embodiment of the cosmetology training manikin securing apparatus attached to a workstation via the first horizontal member, the second horizontal member, the height adjustment member, and the third horizontal member.

FIG. 22 illustrates another front perspective view showing a manikin secured to the second embodiment of the cosmetology training manikin securing apparatus attached to the workstation.

### DETAILED DESCRIPTION OF THE INVENTION

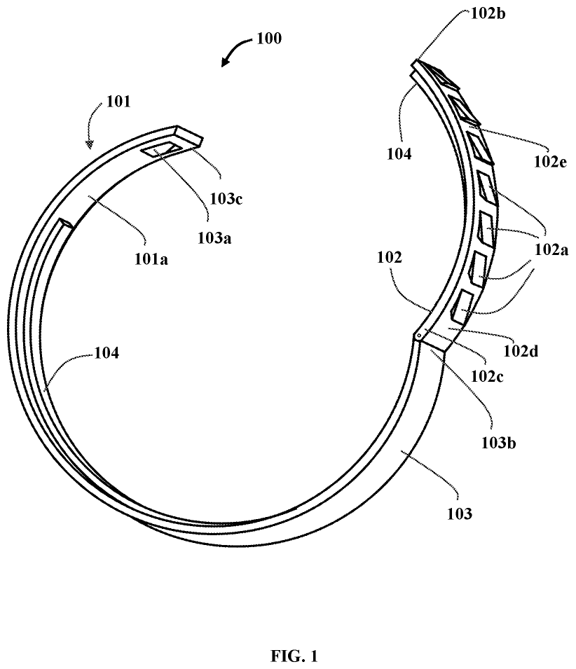

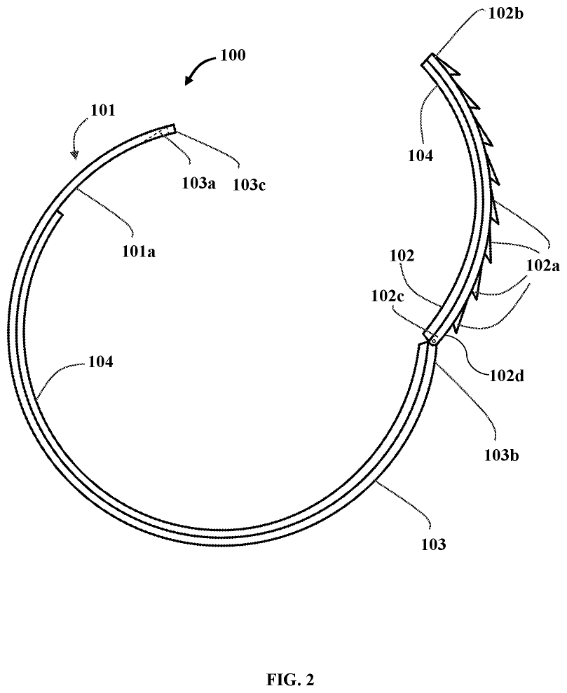

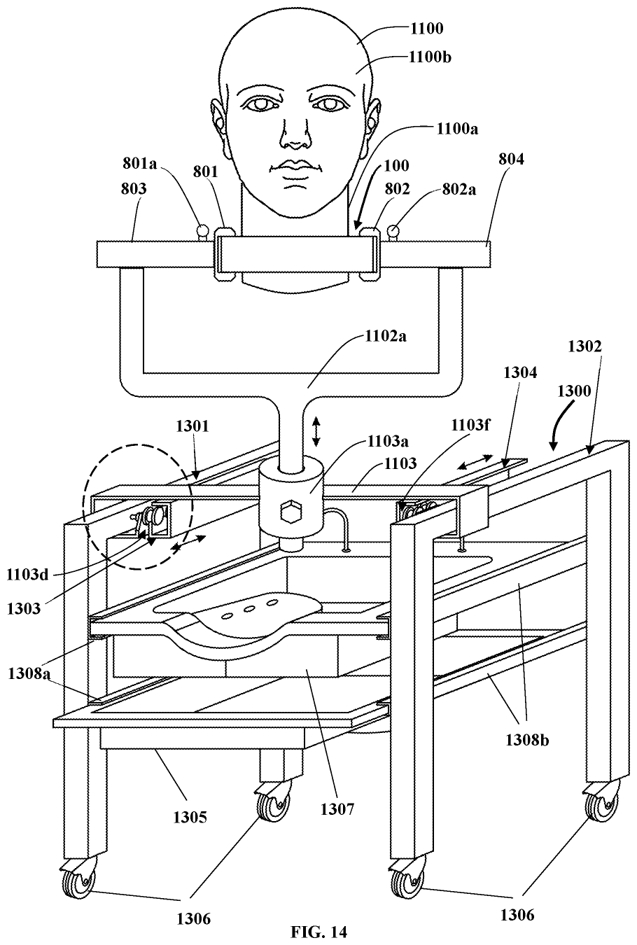

Disclosed herein are embodiments of a cosmetology training manikin securing apparatus for securing a manikin to a workstation. The cosmetology training manikin securing apparatus is used in the cosmetology industry, for example, in beauty schools, cosmetology salons, massage parlors, etc., and for personal beauty needs. FIG. 1 illustrates a top perspective view of a first embodiment of the cosmetology training manikin securing apparatus 100 comprising a generally circular brace member 101. The generally circular brace member 101 is configured to secure a manikin 1100 to a workstation 1300 as illustrated in FIG. 14. The generally circular brace member 101 comprises a first section 102, a second section 103, and a rib 104. FIG. 2 illustrates a top plan view of the first embodiment of the cosmetology training manikin securing apparatus 100, showing the first section 102 of the generally circular brace member 101 in an open position with respect to the second section 103 of the generally circular brace member 101. The first section 102 extends along a quarter length of a circumference of the generally circular brace member 101 as illustrated in FIGS. 1-2. In an embodiment, a length of the first section 102 is longer than the length of the quarter length of the circumference of the generally circular brace member 101.

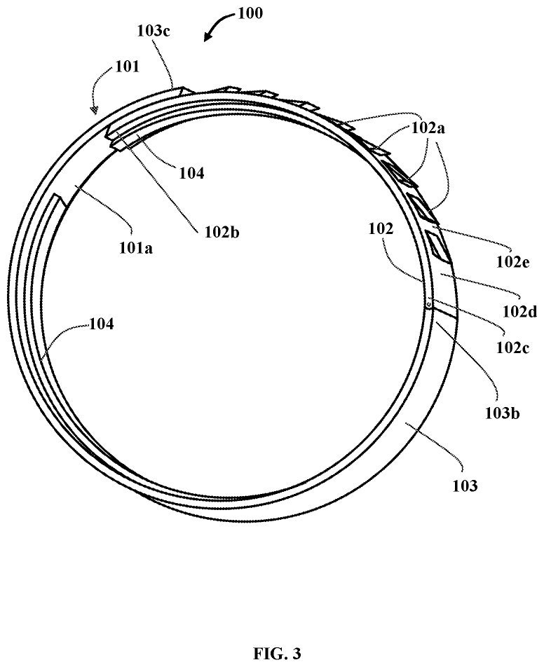

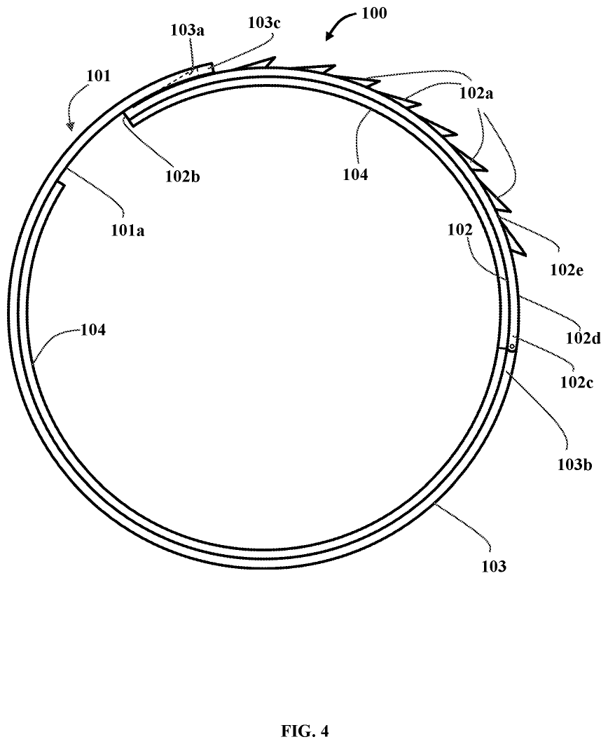

FIG. 3 illustrates a top perspective view of the first embodiment of the cosmetology training manikin securing apparatus 100, showing the first section 102 of the generally circular brace member 101 in a closed position with respect to the second section 103 of the generally circular brace member 101. FIG. 4 illustrates a top plan view of the first embodiment of the cosmetology training manikin securing apparatus 100, showing the first section 102 of the generally circular brace member 101 in the closed position with respect to the second section 103 of the circular brace member 101. As illustrated in FIGS. 1-4, the first section 102 comprises multiple teeth 102a, where each tooth 102a is oriented for slotting into a slot 103a in the second section 103 of the generally circular brace member 101. The teeth 102a are arranged linearly along an outer circumference 102d of the first section 102 as illustrated in FIGS. 1-4. A predetermined gap 102e is maintained between adjacent teeth 102a as shown in FIG. 1 and FIGS. 3-4. The predetermined gap 102e is, for example, between about 2 millimeters (mm) to about 10 mm. The second section 103 comprises a first end 103b and a second end 103c as illustrated in FIGS. 1-4. The first end 103b of the second section 103 is hingedly attached to a second end 102c of the first section 102 as illustrated in FIGS. 1-2. The second section 103 extends along three quarters (¾th) length of the circumference of the generally circular brace member 101. In an embodiment, length of the second section 103 is more than half the length of the circumference of the generally circular brace member 101 but less than three quarters the length of the circumference of the generally circular brace member 101 as illustrated in FIG. 2 and FIG. 4.

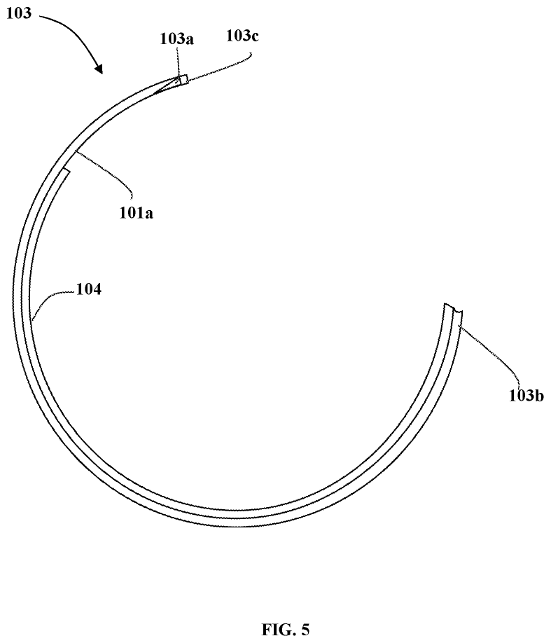

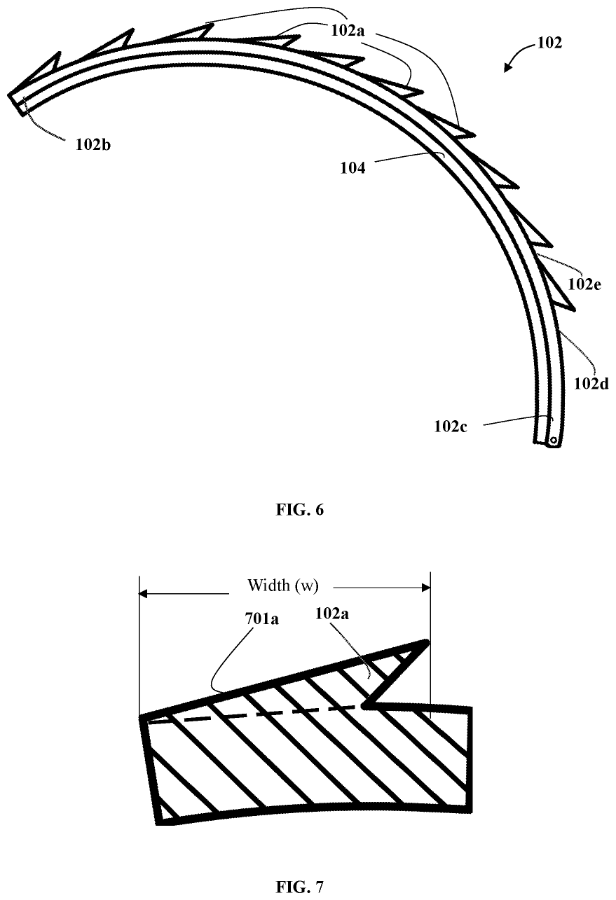

FIG. 5 illustrates a top plan view of the second section 103 of the generally circular brace member 101. As illustrated in FIGS. 1-2 and FIGS. 4-5, the slot 103a is disposed at the second end 103c of the second section 103. The slot 103a in the second section 103 is configured to receive and secure one of the teeth 102a of the first section 102 to secure the first section 102 to the second section 103 and close the generally circular brace member 101 as illustrated in FIGS. 3-4. The rib 104 is disposed on the inner perimeter 101a of the generally circular brace member 101. The rib 104 is disposed substantially on the middle section of the width of the generally circular brace member 101. The rib 104 extends from a first end 102b of the first section 102 to the second end 102c of the first section 102 as illustrated in FIG. 2, FIG. 4, and FIG. 6. The rib 104 further extends from the first end 103b of the second section 103 and terminates proximal to the second end 103c of the second section 103 behind the slot 103a as illustrated in FIGS. 1-2 and FIGS. 4-5. The rib 104 provides strength to the brace member 101. In an embodiment, the rib 104 provides resistance to a bending force acting on the outer circumference of the brace member 101 that tries to squeeze the brace member 101. In an embodiment, the rib 104 also provides resistance to a bending force acting on the inner circumference of the brace member 101 that tries to pull the ends 103c and 103b of the brace member 101 apart. Furthermore, the rib 104 provides elasticity to the brace member 101 by substantially returning the brace member 101 to its original shape and diameter after the tooth 102e is removed from the slot 103a. The generally circular brace member is 101 configured to be tightly wrapped around a neck 1100a of a manikin 1100 as illustrated in FIGS. 11-12 and FIG. 14. As illustrated in FIG. 4, FIGS. 11-12 and FIG. 14, one of the teeth 102a that is most proximal to the slot 103a is slotted into the slot 103a to secure the manikin 1100 to the generally circular brace member 101.

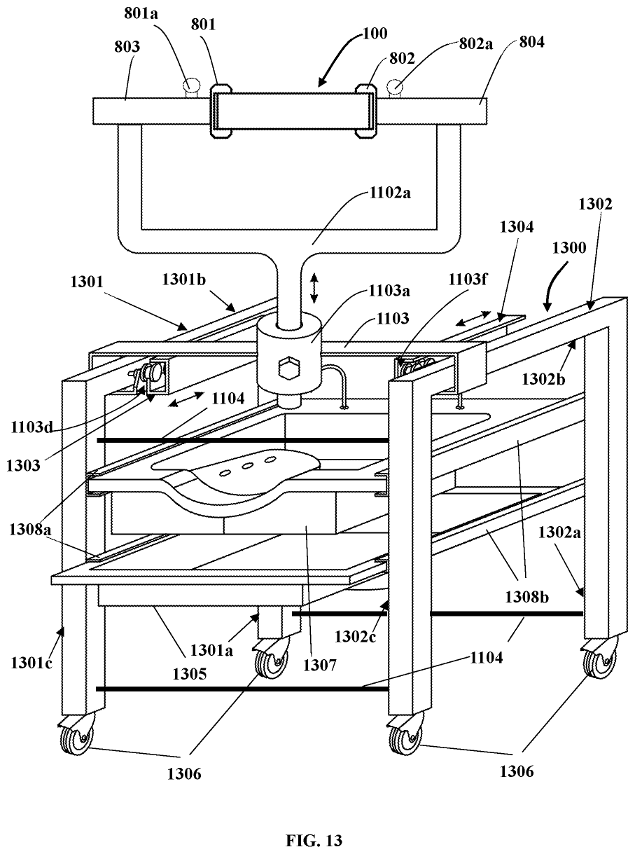

FIG. 6 illustrates a top plan view of the first section 102 of the generally circular brace member 101. FIG. 7 illustrates a cross-sectional view of a single tooth 102a of a plurality of teeth 102a in the first section 102 of the generally circular brace member 101. In an embodiment as illustrated in FIG. 7, a cross-section of each tooth 102a in the first section 102 of the generally circular brace member 101 is in the shape of an obtuse triangle. A longer side 701a of each tooth 102a slopes gradually upwards from the first end 102b of the first section 102 towards the second end 102c of the first section 102. In an example, a width (w) of each tooth 102a is about 0.5 centimeters (cm) to about 3 cm as illustrated in FIG. 7. In an embodiment, the generally circular brace member 101 is further configured to be secured to the workstation 1300 as illustrated in FIGS. 13-14.

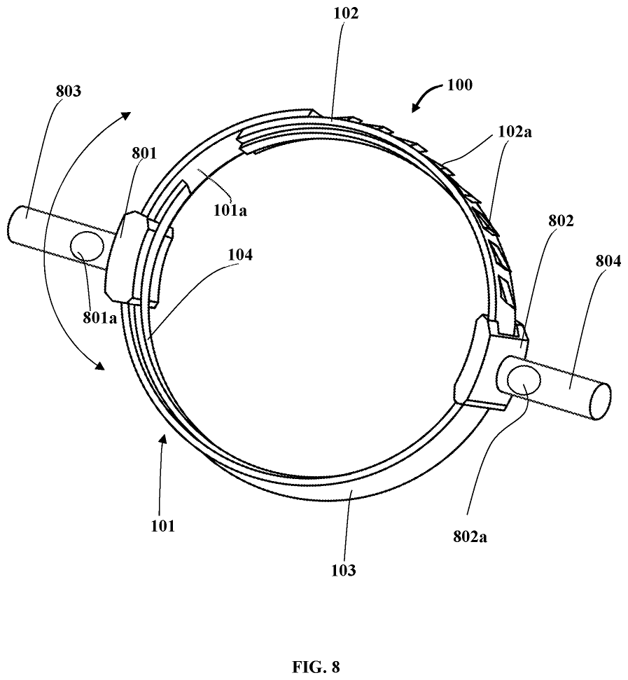

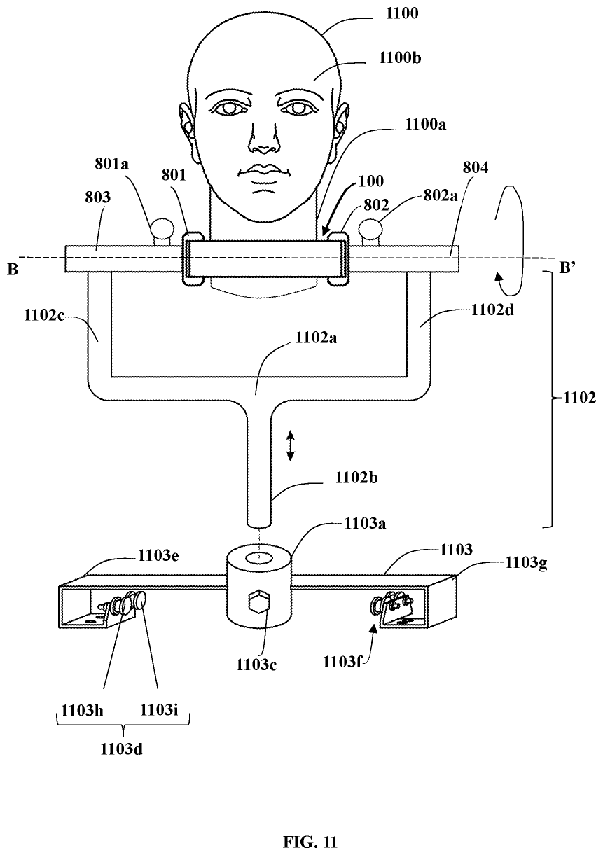

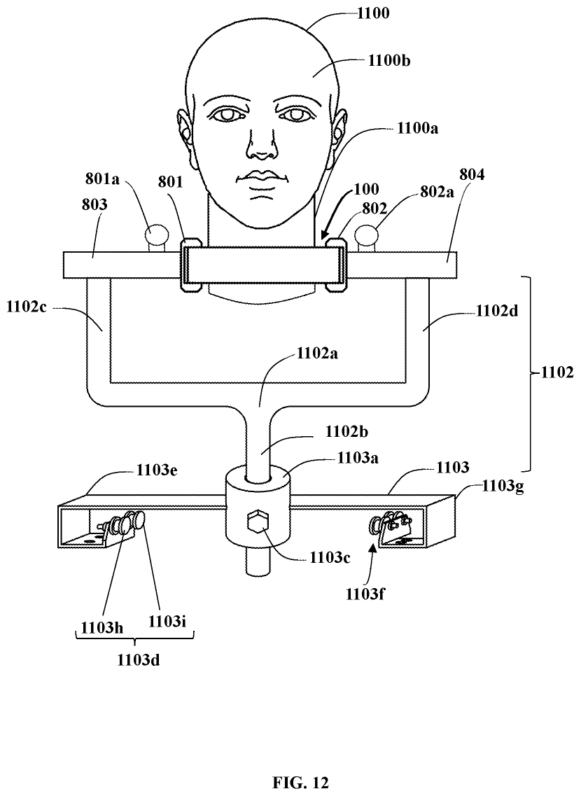

In an embodiment, the cosmetology training manikin securing apparatus 100 further comprises a first holder 801 and a second holder 802 configured to slidably engage with the generally circular brace member 101. The first holder 801 and the second holder 802 have a generally c-shaped cross-section as illustrated in FIG. 10 to provide clearance to the rib 104 in the generally circular brace member 101. FIG. 8 illustrates a top perspective view of the first embodiment of the cosmetology training manikin securing apparatus 100 comprising the first holder 801 and the second holder 802 slidably engaging the generally circular brace member 101. In an embodiment, The ability of the first holder 801 and the second holder 802 to slidably engage the generally circular brace member 101 allows a manikin's 1100 head 1100b secured to the generally circular brace member 101 to be rotated about a vertical axis. In an embodiment, the rib 104 protrudes out of the first and second holders 801 to ensure that the rib 104 can grip manikin's 1100 head 1100a. The first holder 801 and the second holder 802 are configured to secure the generally circular brace member 101 to a height adjustment member 1102 as illustrated in FIGS. 11-12. The first holder 801 is rotatably attached to a first horizontal member 803 and the second holder 802 is rotatably attached to a second horizontal member 804. The first holder 801 and the second holder 802 rotate with respect to first horizontal member 803 and the second horizontal member 804, respectively. This allows the manikin's 1100 head 1100b secured by the generally circular brace member 101 to be rotated. The first horizontal member 803 and the second horizontal member 804 extend outwardly from the first holder 801 and the second holder 802, respectively. In an embodiment, the first horizontal member 803 and the second horizontal member 804 have a cylindrical shape with a hollow end to accommodate shafts 801d and 802d of the first holder 801 and the second holder 802, respectively. In an embodiment, the first holder 801 and the second holder 802 comprise threaded knobs 801a and 802a, respectively, configured to secure the first holder 801 and the second holder 802 to the first horizontal member 803 and the second horizontal member 804, respectively. In example, the length of each of the first horizontal member 803 and the second horizontal member 804 is about 1 inch to about 3 inches, and the diameter of each of the first horizontal member 803 and the second horizontal member 804 is about 1.5 cm to about 3 cm.

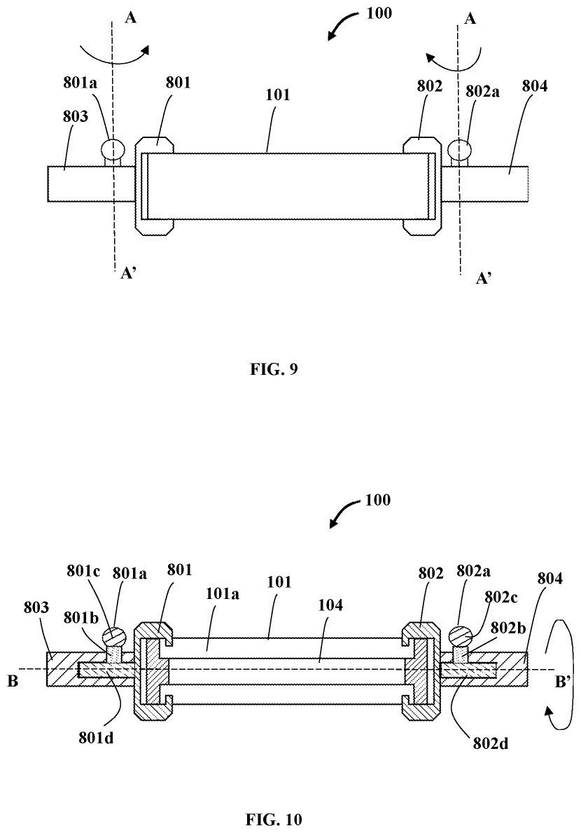

FIG. 9 illustrates a front elevation view of the first embodiment of the cosmetology training manikin securing apparatus 100 comprising the first holder 801, the second holder 802, the first horizontal member 803, and the second horizontal member 804. FIG. 10 illustrates a cross-sectional view of the first embodiment of the cosmetology training manikin securing apparatus 100 comprising the first holder 801, the second holder 802, the first horizontal member 803, and the second horizontal member 804. As illustrated in FIG. 10, the threaded knobs 801a and 802a comprise threaded stems 801b and 802b, respectively, configured to be threaded into respective threaded holes (not shown) in the first horizontal member 803 and the second horizontal member 804. The threaded stem 801b engages with a shaft 801d of the first holder 801 that protrudes into the first horizontal member 803, and the threaded stem 802b engages with a shaft 802d of the second holder 802 that protrudes into the second horizontal member 804. As illustrated in FIG. 10, the threaded knobs 801a and 802a also comprise knob handles 801c and 802c attached to one end of the threaded stems 801b and 802b, respectively. In an embodiment, the threaded knobs 801a and 802a are used to regulate the rotational motion of the first holder 801 and the second holder 802, respectively, with respect to the first horizontal member 803 and the second horizontal member 804, respectively. In an embodiment, turning the threaded knobs 801a and 802a in a clockwise direction about a vertical axis AA′ as illustrated in FIG. 9, rigidly secures the first holder 801 and the second holder 802 to the first horizontal member 803 and the second horizontal member 804, and turning the threaded knobs 801a and 802a in a counterclockwise direction about the vertical axis AA′ as illustrated in FIG. 9, allows the first holder 801 and the second holder 802 to freely rotate relative to the first horizontal member 803 and the second horizontal member 804, respectively.

In an embodiment, the generally circular brace member 101 of the cosmetology training manikin securing apparatus 100 is detachable from the first holder 801 and the second holder 802 by removing the tooth 102a out of the slot 103a illustrated in FIG. 4, rotating the generally circular brace member 101, and sliding the generally circular brace member 101 out of the first holder 801 and the second holder 802.

In an embodiment, the height adjustment member 1102 comprises a Y-shaped member 1102a comprising a shaft 1102b, a first prong 1102c, and a second prong 1102d as illustrated in FIG. 11. The first horizontal member 803 is attached to the first prong 1102c of the height adjustment member 1102 and the second horizontal member 804 is attached to the second prong 1102d of the height adjustment member 1102 as illustrated in FIG. 11. The first horizontal member 803 and the second horizontal member 804 are attached to the first prong 1102c and the second prong 1102d by one of welding, threading, gluing, etc. In an embodiment, the cosmetology training manikin securing apparatus 100 further comprises a third horizontal member 1103 configured to slidably secure the height adjustment member 1102 to the workstation 1300 illustrated in FIGS. 13-14. FIG. 11 illustrates a front perspective view showing the first embodiment of the cosmetology training manikin securing apparatus 100 secured to the third horizontal member 1103 through the height adjustment member 1102, the first horizontal member 803, and the second horizontal member 804. Also illustrated in FIG. 11 is the generally circular brace member 101 of the cosmetology training manikin securing apparatus 100 illustrated in FIGS. 1-4, tightly wrapped and secured around the neck 1100a of a manikin 1100. In an embodiment, the cosmetology training manikin securing apparatus 100 further comprises a shaft collar 1103a disposed at a substantially mid-section of the third horizontal member 1103. The shaft collar 1103a is configured to slidably accommodate the shaft 1102b of the Y-shaped member 1102a and secure the Y-shaped member 1102a at a predetermined height above the workstation 1300 in an upright position. The height adjustment member 1102 being suspended above the shaft collar 1103a of the third horizontal member 1103 is illustrated in FIG. 11.

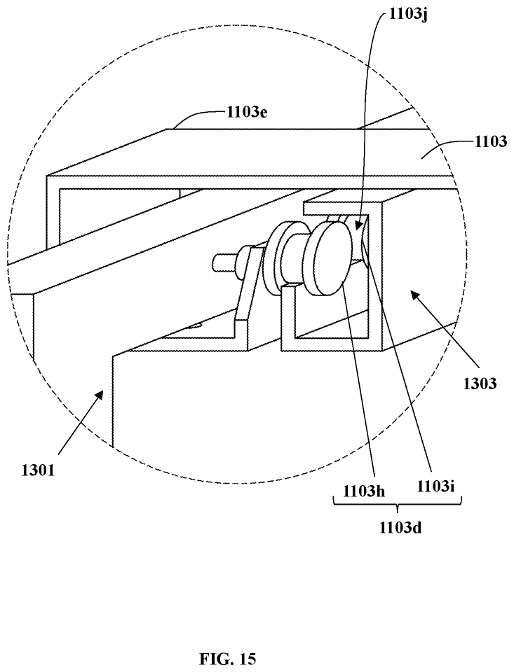

FIG. 12 illustrates another front perspective view showing the shaft 1102b of the Y-shaped member 1102a of the height adjustment member 1102 secured to the shaft collar 1103a of the third horizontal member 1103. The shaft collar 1103a comprises a threaded knob 1103c configured to be screwed in and out of a threaded hole (not shown) in the shaft collar 1103a to secure the shaft 1102b of the Y-shaped member 1102a in a fixed position in the shaft collar 1103a or to allow the shaft 1102b of the Y-shaped member 1102a to slide in and out of the shaft collar 1103a. By sliding the shaft 1102b of the Y-shaped member 1102a in and out of the shaft collar 1103a, a user may adjust the height of the Y-shaped member 1102a and thereby the manikin's 1100 head 1100b. In an embodiment, the shaft 1102b has a circular cross-section and the shaft collar 1103a also has a circular opening (not shown) to slidably accommodate the shaft 1102b of the Y-shaped member 1102a. The shaft 1102b, the Y-shaped member 1102a and thereby the attached manikin's 1100 head 1100b may be rotated by loosening the threaded knob 1103c and the threaded knob 1103c is tightened once the Y-shaped member 1102a and thereby the attached manikin's 1100 head 1100b are in a predetermined position. In an embodiment, the threaded knob 1103c may be partially tightened to prevent the shaft 1102b from sliding downwards but at the same time allow the shaft 1102b to be rotated. In an embodiment as illustrated in FIGS. 11-12, the cosmetology training manikin securing apparatus 100 further comprises a first roller wheel set 1103d and a second roller wheel set 1103f, each comprising roller wheels 1103h and 1103i as disclosed in the description of FIG. 15. The first roller wheel set 1103d is suspended underneath a first end 1103e of the third horizontal member 1103. The second roller wheel set 1103f is suspended underneath a second end 1103g of the third horizontal member 1103.

FIG. 13 illustrates a front perspective view showing the first embodiment of the cosmetology training manikin securing apparatus 100 attached to a workstation 1300 via the first horizontal member 803, the second horizontal member 804, the height adjustment member 1102, and the third horizontal member 1103. The generally circular brace member 101 of the cosmetology training manikin securing apparatus 100 illustrated in FIGS. 1-4, is secured to the workstation 1300 as illustrated in FIGS. 13-14. The workstation 1300 comprises a first frame member 1301 and a second frame member 1302 disposed height adjustment to each other. The first frame member 1301 is attached to the second frame member 1301 via a fourth horizontal members 1104. The workstation 1300 further comprises a first channel 1303 attached to the first frame member 1301 and a second channel 1304 attached to the second frame member 1302. The first and second frame members 1301 and 1302 have a substantially square shaped cross-section. Furthermore, the first and second frame members 1301 and 1302 have a substantially inverted-U-shaped structure. The adjacent sides 1301a-1301c of the first frame member 1301 are perpendicular to each other, and the adjacent sides 1302a-1302c of the second frame member 1302 are perpendicular to each other. The first channel 1303 is attached to the top side 1301b of the first frame member 1301 via a support piece (not shown). The first channel 1303 is parallel to the top side 1301b. Furthermore, a gap of about 2 mm to about 2.5 cm is maintained between the first channel 1303 and the top side 1301b of the first frame member 1301 to enable uninterrupted movement of the first roller wheel set 1103d. The second channel 1304 is attached to the top side 1302b of the second frame member 1302 via a support piece (not shown). The second channel 1304 is parallel to the top side 1302b. Furthermore, a gap of about 2 mm to about 2.5 cm is maintained between the second channel 1304 and the top side 1302b of the second frame member 1302 to enable uninterrupted movement of the second roller wheel set 1103f.

FIG. 14 illustrates another front perspective view showing a manikin 1100 secured to the first embodiment of the cosmetology training manikin securing apparatus 100 attached to the workstation 1300. The generally circular brace member 101 illustrated in FIGS. 1-4, is tightly wrapped around the neck 1100a of the manikin 1100, and the neck 1100a is secured by slotting one of the teeth 102a into the slot 103a of the generally circular brace member 101 as illustrated in FIG. 4.

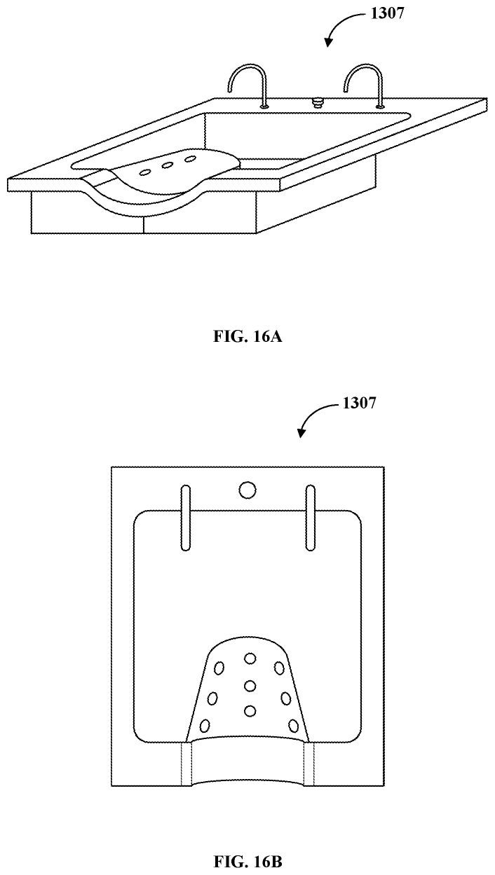

FIG. 15 illustrates an enlarged view showing the first roller wheel set 1103d suspended underneath the first end 1103e of the third horizontal member 1103. The first roller wheel set 1103d is rollably accommodated within the first channel 1303 of the workstation 1300, and the second roller wheel set 1103f is rollably accommodated within the second channel 1304 of the workstation 1300 as illustrated in FIGS. 13-14. As illustrated in FIGS. 11-12 and FIG. 15, the first roller wheel set 1103d comprises at least two roller wheels 1103h and 1103i arranged one behind the other wheel. A predetermined gap 1103j is maintained between the wheels 1103h and 1103i in the first roller wheel set 1103d as illustrated in FIG. 15. Similar to the first roller wheel set 1103d, the second roller wheel set 1103f also comprises at least two roller wheels (not shown) arranged one behind the other wheel. The first roller wheel set 1103d and the second roller wheel set 1103f allow the third horizontal member 1103, and the components mounted on it or attached to it to roll freely in the first and second channels 1303 and 1304. As illustrated in FIGS. 13-14, the first channel 1303 is secured to the first frame member 1301 of the workstation 1300 and the second channel 1304 is secured to the second frame member 1302 of the workstation 1300. In an embodiment, the first frame member 1301 and the second frame member 1302 of the workstation 1300 comprise multiple channels 1308a and 1308b, respectively, for slidably accommodating, for example, one or more of a shampoo sink 1307, a basin (not shown), a bowl (not shown), a bucket (not shown), and an accessory tray 1305. FIGS. 16A-16B illustrate a front perspective view and a top plan view, respectively, of a shampoo sink 1307 configured to be slidably accommodated in the workstation 1300. In an embodiment, the workstation 1300 comprises caster wheels 1306 attached to the first frame member 1301 and the second frame member 1302 of the workstation 1300. The caster wheels 1306 support and provide mobility to the workstation 1300.

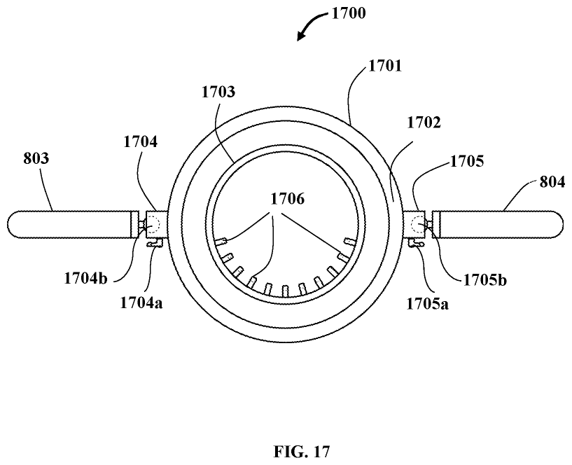

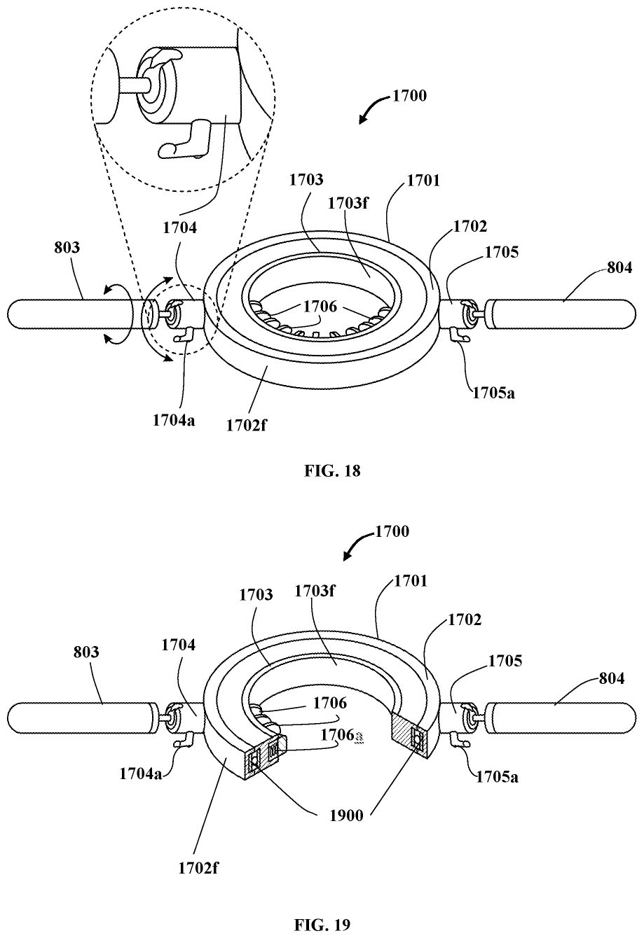

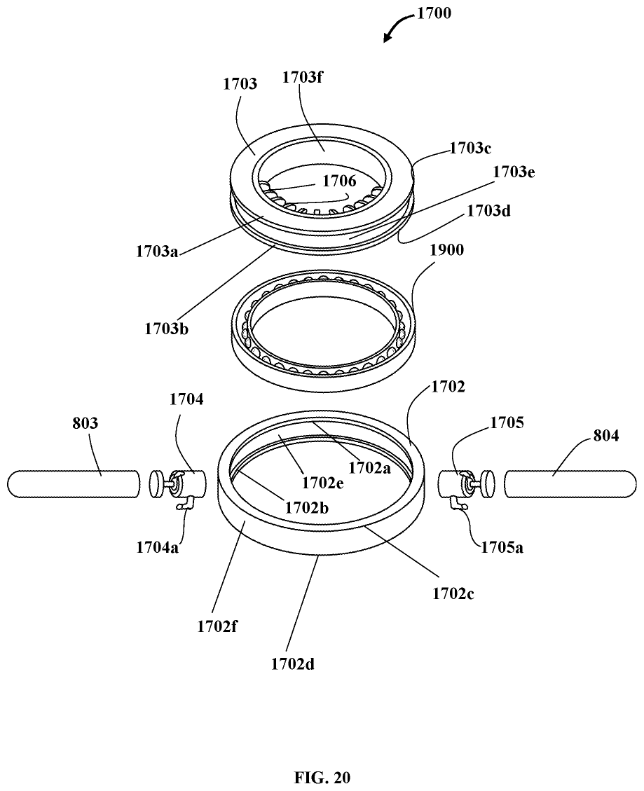

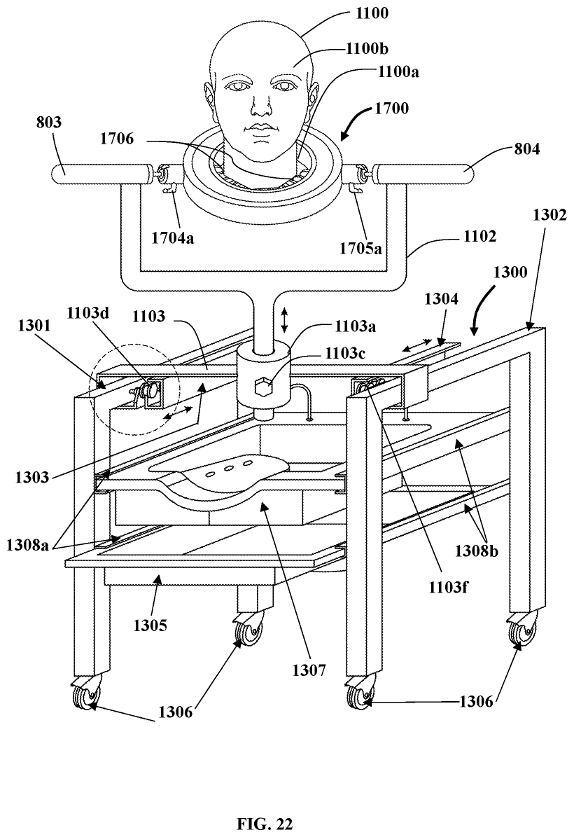

FIG. 17 illustrates a top plan view of a second embodiment of the cosmetology training manikin securing apparatus 1700 comprising a brace 1701, a first swivel ball head 1704, and a second swivel ball head 1705. The cosmetology training manikin securing apparatus 1700 of the second embodiment secures a manikin 1100 to a workstation 1300 as illustrated in FIG. 22. The brace 1701 of the cosmetology training manikin securing apparatus 1700 is configured to secure the manikin 1100 to the workstation 1300. The brace 1701 comprises a first ring member 1702 and a second ring member 1703. The first ring member 1702 comprises a first wall 1702a and a second wall 1702b as illustrated in FIG. 20. The first wall 1702a is disposed on an upper side 1702c of an inner section 1702e of the first ring member 1702 as illustrated in FIG. 20. The second wall 1702b is disposed on a lower side 1702d of the inner section 1702e of the first ring member 1702. The second ring member 1703 comprises a first wall 1703a and a second wall 1703b as illustrated in FIG. 20. The first wall 1703a of the second ring member 1703 is disposed on an upper side 1703c of an outer section 1703e of the second ring member 1703 as illustrated in FIG. 20. The second wall 1703b of the second ring member 1703 is disposed on a lower side 1703d of the outer section 1703e of the second ring member 1703 as illustrated in FIG. 20. The second ring member 1703 further comprises multiple spring-loaded retention members 1706 disposed on an inner section 1703f of the second ring member 1703 as illustrated in FIGS. 18-20. The spring-loaded retention members 1706 are configured to securely hold a neck 1100a of the manikin 1100 when the neck 1100a is inserted into the second ring member 1703 as illustrated in FIG. 22. The spring-loaded retention members 1706 comprise springs 1706a as shown in FIG. 19. The spring-loaded retention members 1706 are pushed back by the neck 1100a of the manikin 1100 when the neck 1100a of the manikin 1100 is inserted into the inner section 1703f of the second ring member 1703. The spring-loaded retention members 1706 then push against the neck 1100a of the manikin 1100 and securely hold the neck 1100a of the manikin 1100. In an embodiment, the spring-loaded retention members 1706 may be pushed into the inner section 1703f of the second ring member 1703 by about 0.5 inch to about 1.5 inch and can be therefore adjusted to accommodate manikins 1100 having necks 1100a of various sizes.

The first swivel ball head 1704 is attached to an outer section 1702f of the first ring member 1702 of the brace 1701 as illustrated in FIGS. 18-20. The second swivel ball head 1705 is attached to the outer section 1702f of the first ring member 1702 of the brace 1701, diametrically opposite to the first swivel ball head 1704. The first swivel ball head 1704 is rotatably attached to a first horizontal member 803. The second swivel ball head 1705 is rotatably attached to a second horizontal member 804. Balls 1704b and 1705b located within the first swivel ball head 1704 and the second swivel ball head 1705, respectively, establish the rotatable attachment of the first swivel ball head 1704 and the second swivel ball head 1705 to the first horizontal member 803 and the second horizontal member 804, respectively. In an embodiment, the first swivel ball head 1704 and the second swivel ball head 1705 comprise levers 1704a and 1705a, respectively, configured to tighten or loosen swivel movement of the balls 1704b and 1705b located within the first swivel ball head 1704 and the second swivel ball head 1705, respectively. The levers 1704a and 1705a of the first swivel ball head 1704 and the second swivel ball head 1705, respectively, are configured to secure the first swivel ball head 1704 and the second swivel ball head 1705 to the first horizontal member 803 and the second horizontal member 804, respectively. The levers 1704a and 1705a are each attached to threaded screws (not shown) that are located within a body of the first swivel ball head 1704 and the second swivel ball head 1705. The levers 1704a and 1705a are turned in a clockwise direction to drive the threaded screws (not shown) against the balls 1704b and 1705b, respectively. This tightens or stops the swivel movement of the balls 1704b and 1705b located within the first swivel ball head 1704 and the second swivel ball head 1705, respectively. Turning the levers 1704a and 1705a in an anti-clockwise direction drives the threaded screws (not shown) away from the balls 1704b and 1705b, respectively. This loosens the grip of the threaded screws (not shown) on the balls 1704b and 1705b and allows the swivel movement of the balls 1704b and 1705b. The brace 1701 along with the manikin 1100 head 1100b secured by the spring-loaded retention members 1706 may be aligned horizontally when the grip of the threaded screws (not shown) on the balls 1704b and 1705b are loosened. The levers 1704a and 1705a may then be turned in a clockwise direction to drive the threaded screws (not shown) against the balls 1704b and 1705b, respectively, and tighten or stop the swivel movement of the balls 1704b and 1705b.

FIG. 18 illustrates a top perspective view of the second embodiment of the cosmetology training manikin securing apparatus 1700, showing an enlarged view of the first swivel ball head 1704. FIG. 19 illustrates a top perspective view showing a sectional view of the second embodiment of the cosmetology training manikin securing apparatus 1700. FIG. 20 illustrates an exploded, top perspective view of the second embodiment of the cosmetology training manikin securing apparatus 1700. In addition to the first ring member 1702 and the second ring member 1703, the brace 1701 comprises a circular bearing 1900 as illustrated in FIGS. 19-20. The circular bearing 1900 is disposed between the first ring member 1702 and the second ring member 1703. The circular bearing 1900 reduces friction between the first ring member 1702 and the second ring member 1703, and enables the first ring member 1702 to rotate freely with respect to the second ring member 1703.

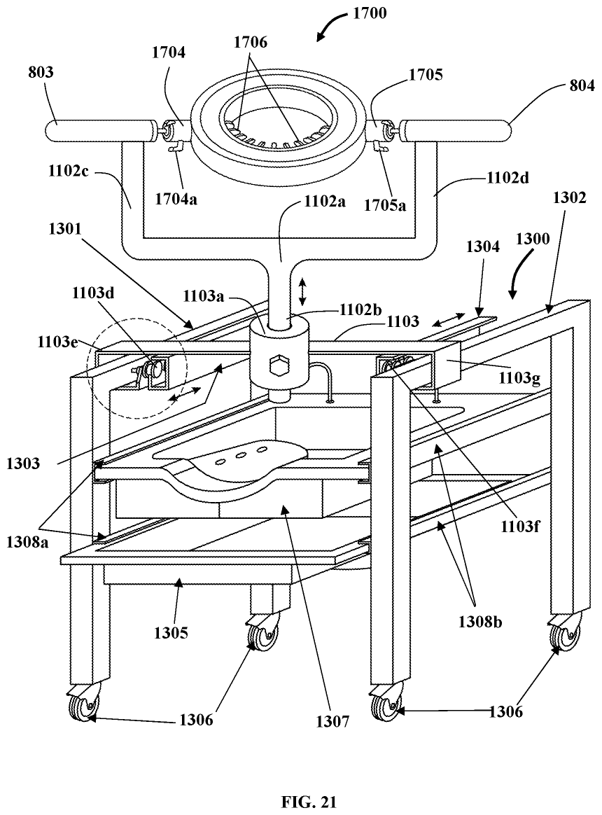

The brace 1701 is further configured to be secured to a workstation 1300 through the first swivel ball head 1704 and the second swivel ball head 1705. FIG. 21 illustrates a front perspective view showing the second embodiment of the cosmetology training manikin securing apparatus 1700 attached to the workstation 1300 via the first horizontal member 803, the second horizontal member 804, a height adjustment member 1102, and the third horizontal member 1103. As illustrated in FIG. 21, the first horizontal member 803 and the second horizontal member 804 are configured to secure the brace 1701 to the height adjustment member 1102. In an embodiment, the height adjustment member 1102 comprises a Y-shaped member 1102a comprising a shaft 1102b, a first prong 1102c, and a second prong 1102d. The first horizontal member 803 is attached to the first prong 1102c and the second horizontal member 804 is attached to the second prong 1102d.

In an embodiment, the cosmetology training manikin securing apparatus 1700 further comprises a third horizontal member 1103 and a shaft collar 1103a. The third horizontal member 1103 is configured to slidably secure the height adjustment member 1102 to the workstation 1300. The shaft collar 1103a is disposed at a substantially mid-section of the third horizontal member 1103. The shaft collar 1103a is configured to slidably accommodate the shaft 1102b of the Y-shaped member 1102a and secure the Y-shaped member 1102a at a predetermined height above the workstation 1300 in an upright position.

In an embodiment, the cosmetology training manikin securing apparatus 1700 further comprises a first roller wheel set 1103d and a second roller wheel set 1103f. The first roller wheel set 1103d is suspended underneath the first end 1103e of the third horizontal member 1103. The first roller wheel set 1103d is rollably accommodated within the first channel 1303 of the workstation 1300. The second roller wheel set 1103f is suspended underneath the second end 1103g of the third horizontal member 1103. The second roller wheel set 1103f is rollably accommodated within the second channel 1304 of the workstation 1300.

The first channel 1303 is secured to the first frame member 1301 of the workstation 1300. The second channel 1304 is secured to the second frame member 1302 of the workstation 1300. The first frame member 1301 and the second frame member 1302 of the workstation 1300 comprise multiple channels 1308a and 1308b, respectively, for slidably accommodating one or more of a shampoo sink 1307, a basin (not shown), a bowl (not shown), a bucket (not shown), and an accessory tray 1305. In an embodiment, the workstation 1300 comprises caster wheels 1306 attached to the first frame member 1301 and the second frame member 1302 of the workstation 1300.

FIG. 22 illustrates another front perspective view showing a manikin 1100 secured to the second embodiment of the cosmetology training manikin securing apparatus 1700 attached to the workstation 1300. The neck 1100a of the manikin 1100 is inserted into the brace 1701 illustrated in FIGS. 17-18 and secured by the spring-loaded retention members 1706 as illustrated in FIG. 22. In an embodiment, the brace 1701 of the cosmetology training manikin securing apparatus 1700 is detachably attached to the first swivel ball head 1704 and the second swivel ball head 1705. In this embodiment, the brace 1701 is detachable from the first swivel ball head 1704 and the second swivel ball head 1705 to leave the first horizontal member 803, the second horizontal member 804, the height adjustment member 1102, the third horizontal member 1103, and the shaft collar 1103a attached to the workstation 1300.

The cosmetology training manikin securing apparatuses 100 and 1700 illustrated in FIGS. 3-4 and FIGS. 17-18, respectively, allow a manikin's 1100 head 1100b to be secured in a desired orientation, for example, in a horizontal orientation for shampooing and/or rinsing, in an upright or vertical position for cutting hair, etc. The threaded knobs 801a and 802a are rotated or turned in a counterclockwise direction about the vertical axis AA′ illustrated in FIG. 9. The threaded stem 801b disengages the shaft 801d of the first holder 801, and the threaded stem 802b disengages the shaft 802d of the second holder 802. The first holder 801 and the second holder 802 are now able to freely rotate relative to the first horizontal member 803 and the second horizontal member 804, respectively. The shaft 801d, the first holder 801, the shaft 802d, the second holder 802, the generally circular brace member 101, and the manikin's 1100 head 1100b secured to the generally circular brace member 101 are rotated as a single unit along a horizontal axis BB′, as shown in FIGS. 10 and 11. The shaft 801d, the first holder 801, the shaft 802d, the second holder 802, the generally circular brace member 101, and the manikin's 1100 head 1100b secured to the generally circular brace member 101 are then fixed in a desirable horizontal position by tightening the threaded knobs 801a and 802a by turning the threaded knobs 801a and 802a in a counterclockwise direction about the vertical axis AA′ illustrated in FIG. 9.

Moreover, the cosmetology training manikin securing apparatuses 100 and 1700 allow the manikin's 1100 head 1100b to be rotated about a desired axis. For example, while making a wig, the user may rotate the manikin's 1100 head 1100b about a vertical axis to access the front, rear, and sides of the wig placed on the manikin's 1100 head 1100b. Furthermore, the cosmetology training manikin securing apparatuses 100 and 1700 allow a user to adjust their height to provide a convenient access to the manikin's 1100 head 1100b. For example, for eye and other face cosmetic application training, through the height adjustment apparatus 1102 of each of the cosmetology training manikin securing apparatuses 100 and 1700, the user increases the height of the apparatus on which the manikin's 1100 head 1100b is mounted to bring the manikin's 1100 head 1100b in-line with the user's face.

Each of the braces 101 and 1701 of the cosmetology training manikin securing apparatuses 100 and 1700 illustrated in FIGS. 3-4 and FIGS. 17-18, respectively, resembles a narrow bracket and measures, for example, about 25 inches to about 30 inches in length and about 1.5 inches to about 2.0 inches in thickness. The circumference of the generally circular brace member 101 of the cosmetology training manikin securing apparatus 100 and the diameter of the inner section 1703f of the second ring member 1703 of the cosmetology training manikin securing apparatus 1700 is, for example, about 16 inches to about 23 inches.

The cosmetology training manikin securing apparatuses 100 and 1700 are adjustable to accommodate manikins 1100 having necks 1100a of various sizes. Each of the braces 101 and 1701 of the cosmetology training manikin securing apparatuses 100 and 1700, respectively, holds the manikin's 1100 neck 1100a firmly for a user to move the manikin's 1100 head 1100b as needed, and secures the manikin's 1100 head 1100b to free the user's hands from contacting the manikin 1100 or the cosmetology training manikin securing apparatuses 100 and 1700 while performing actions, for example, shampooing, brushing, combing, massaging, etc., on the manikin 1100. The cosmetology training manikin securing apparatuses 100 and 1700 allow the manikin's 1100 hair (not shown) to hang freely in a more natural falling position. The cosmetology training manikin securing apparatuses 100 and 1700 allow the user, for example, a hair stylist, to have control and manageability over movement of the manikin's 1100 head 1100b, thereby preventing the manikin's 1100 hair from easily tangling, knotting, or even falling into soiled water remaining in a shampoo sink 1307 illustrated in FIG. 14, FIGS. 16A-16B, and FIG. 22.

The cosmetology training manikin securing apparatuses 100 and 1700 also serve for ergonomic purposes to alleviate excessive strain on the user's shoulders, neck, and back. The cosmetology training manikin securing apparatuses 100 and 1700 can be adjusted, for example, pulled-up and locked as illustrated in FIG. 12, FIG. 14, and FIG. 22, to allow the manikin's 1100 head 1100b to stand firmly in an upright position at a desired height when required. This height adjustment brings the manikin's 1100 head 1100b higher and closer to the user, thereby preventing any excessive bending and strain on the user's shoulders, neck, back, etc. The cosmetology training manikin securing apparatuses 100 and 1700 are also used in a way to simulate a shampoo service to a live client in a salon.

The cosmetology training manikin securing apparatuses 100 and 1700 also help in preventing excessive water spraying out of the shampoo sink 1307 and onto the floor and/or dry areas. To prevent the spraying out of excessive water, the cosmetology training manikin securing apparatuses 100 and 1700 are rotated to orient the manikin's 1100 head 1100b in a horizontal position to allow the user to direct the spray of water onto the manikin's 1100 head 1100b and down into the shampoo sink 1307. By rolling the roller wheel sets 1103d and 1103f within the respective channels 1303 and 1304 of the workstation 1300, the third horizontal member 1103 of each of the cosmetology training manikin securing apparatuses 100 and 1700 is slid forward or backward alongside and parallel to the edge of the shampoo sink 1307.

In an embodiment, the portable workstation 1300 illustrated in FIGS. 13-14 and FIGS. 21-22, is configured to be rolled and positioned above any free-standing shampoo sink or basin. In this embodiment, a user, for example, a cosmetologist, can perform actions, for example, shampoo, condition, and/or comb the manikin's 1100 hair, as the user normally would when using the cosmetology training manikin securing apparatuses 100 and 1700 paired with the shampoo sink 1307 disclosed above. In an embodiment, a flap comprising about 6 to 9 suction rings is hung from each of three exterior sides of the portable workstation 1300. The flaps are of an adequate length to hang into the shampoo sink 1307 and suction water onto the shampoo sink 1307, thereby preventing any excess water from spraying onto the floor or into dry areas.

In an embodiment, the caster wheels 1306 of the portable workstation 1300 illustrated in FIGS. 13-14 and FIGS. 21-22, comprise brakes. The caster wheels 1306 of the portable workstation 1300 allow for ease of mobility or use as a standalone workstation when performing any wet or dry hair services. In an example, the portable workstation 1300 is about 3.0 feet to about 4.5 feet in height and comprises a lever (not shown) that allows the portable workstation 1300 to be pulled up or pushed down. In an embodiment, the portable workstation 1300 is enabled with wireless technology, for example, Bluetooth® of Bluetooth Sig, Inc., for allowing wireless communication with one or more electronic devices. In an embodiment, the portable workstation 1300 comprises one or more outlets for electrical connections.

In an embodiment, the portable workstation 1300 comprises about 5 to 6 accessory drawers configured to be pushed in or pulled completely out of their respective channels 1308a and 1308b. The user can adjust and position the accessory drawers as desired and according to practical services that the user needs to perform at any given time. The accessory drawers comprise, for example, a flat bed, a large center tray, a classic manikin head stand, a compartmental tray for combs, brushes, a blow dryer, a hang board with rings, clips, etc., a medium size basin or a bowl, etc. In an embodiment, the cosmetology training manikin securing apparatuses 100 and 1700 are used in conjunction with the portable workstation 1300. In another embodiment, the cosmetology training manikin securing apparatuses 100 and 1700 are used without the portable workstation 1300.

The foregoing examples and illustrative implementations of various embodiments have been provided merely for explanation and are in no way to be construed as limiting the embodiments disclosed herein. Dimensions of various parts of the cosmetology training manikin securing apparatuses 100 and 1700 disclosed above are exemplary, and are not limiting of the scope of the embodiments herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

I claim:

1. A cosmetology training manikin securing apparatus for securing a manikin to a workstation, the cosmetology training manikin securing apparatus comprising:
a generally circular brace member configured to secure the manikin to the workstation, the generally circular brace member comprising:
a first section extending along a quarter length of a circumference of the generally circular brace member, wherein the first section comprises a plurality of teeth, wherein each tooth of the plurality of teeth is oriented for slotting into a slot in a second section of the generally circular brace member;
the second section comprising a first end and a second end, wherein the first end of the second section is hingedly attached to a second end of the first section, wherein the second section extends along three quarters length of the circumference of the generally circular brace member, and wherein the slot is disposed at the second end of the second section; and
a rib disposed on an inner perimeter of the generally circular brace member, wherein the rib extends from a first end of the first section and terminates proximal to the second end of the second section behind the slot;
wherein the generally circular brace member is configured to be tightly wrapped around a neck of the manikin, and one of the plurality of teeth most proximal to the slot is slotted into the slot to secure the manikin to the generally circular brace member, and wherein the generally circular brace member is further configured to be secured to the workstation.

2. The cosmetology training manikin securing apparatus of claim 1, wherein a cross-section of the each tooth of the plurality of teeth is of an obtuse triangle, wherein a longer side of the each tooth slopes gradually upwards from the first end of the first section towards the second end of the first section.

3. The cosmetology training manikin securing apparatus of claim 1, further comprising a first holder and a second holder configured to slidably engage with the generally circular brace member, wherein the first holder and the second holder are configured to secure the generally circular brace member to a height adjustment member.

4. The cosmetology training manikin securing apparatus of claim 3, wherein the first holder is rotatably attached to a first horizontal member and the second holder is rotatably attached to a second horizontal member, wherein each of the first holder and the second holder comprises a threaded knob configured to secure the first holder and the second holder to the first horizontal member and the second horizontal member, respectively.

5. The cosmetology training manikin securing apparatus of claim 4, wherein the height adjustment member comprises a Y-shaped member comprising a shaft, a first prong, and a second prong, wherein the first horizontal member is attached to the first prong and the second horizontal member is attached to the second prong.

6. The cosmetology training manikin securing apparatus of claim 5, further comprising:
a third horizontal member configured to slidably secure the height adjustment member to the workstation; and
a shaft collar disposed at a substantially mid-section of the third horizontal member, wherein the shaft collar is configured to slidably accommodate the shaft of the Y-shaped member and secure the Y-shaped member at a predetermined height above the workstation in an upright position.

7. The cosmetology training manikin securing apparatus of claim 6, further comprising:
a first roller wheel set suspended underneath a first end of the third horizontal member, wherein the first roller wheel set is rollably accommodated within a first channel of the workstation; and
a second roller wheel set suspended underneath a second end of the third horizontal member, wherein the second roller wheel set is rollably accommodated within a second channel of the workstation.

8. The cosmetology training manikin securing apparatus of claim 7, wherein the first channel is secured to a first frame member of the workstation and the second channel is secured to a second frame member of the workstation, wherein each of the first frame member and the second frame member of the workstation comprises a plurality of channels configured to slidably accommodate one or more of a shampoo sink, a basin, a bowl, a bucket, and an accessory tray, and wherein the workstation comprises a plurality of caster wheels attached to the first frame member and the second frame member of the workstation.

9. A cosmetology training manikin securing apparatus for securing a manikin to a workstation, the cosmetology training manikin securing apparatus comprising:
a brace configured to secure the manikin to the workstation, the brace comprising:
a first ring member comprising a first wall and a second wall, wherein the first wall is disposed on an upper side of an inner section of the first ring member, and the second wall is disposed on a lower side of the inner section of the first ring member;
a second ring member comprising a first wall and a second wall, wherein the first wall of the second ring member is disposed on an upper side of an outer section of the second ring member, and the second wall of the second ring member is disposed on a lower side of the outer section of the second ring member, wherein the second ring member further comprises a plurality of spring-loaded retention members disposed on an inner section of the second ring member, wherein the plurality of spring-loaded retention members is configured to securely hold a neck of the manikin when the neck is inserted into the second ring member; and
a circular bearing disposed between the first ring member and the second ring member;
a first swivel ball head attached to an outer section of the first ring member of the brace; and
a second swivel ball head attached to the outer section of the first ring member of the brace, diametrically opposite to the first swivel ball head, wherein the brace is further configured to be secured to the workstation through the first swivel ball head and the second swivel ball head.

10. The cosmetology training manikin securing apparatus of claim 9, wherein the first swivel ball head is rotatably attached to a first horizontal member and the second swivel ball head is rotatably attached to a second horizontal member, wherein each of the first swivel ball head and the second swivel ball head comprises a lever configured to one of tighten and loosen a swivel movement of a ball located within the first swivel ball head and the second swivel ball head, and wherein the lever of the each of the first swivel ball head and the second swivel ball head is configured to secure the first swivel ball head and the second swivel ball head to the first horizontal member and the second horizontal member, respectively.

11. The cosmetology training manikin securing apparatus of claim 10, wherein the first horizontal member and the second horizontal member are configured to secure the brace to a height adjustment member.

12. The cosmetology training manikin securing apparatus of claim 11, wherein the height adjustment member comprises a Y-shaped member comprising a shaft, a first prong, and a second prong, wherein the first horizontal member is attached to the first prong and the second horizontal member is attached to the second prong.

13. The cosmetology training manikin securing apparatus of claim 12, further comprising:
a third horizontal member configured to slidably secure the height adjustment member to the workstation; and
a shaft collar disposed at a substantially mid-section of the third horizontal member, wherein the shaft collar is configured to slidably accommodate the shaft of the Y-shaped member and secure the Y-shaped member at a predetermined height above the workstation in an upright position.

14. The cosmetology training manikin securing apparatus of claim 13, further comprising:
a first roller wheel set suspended underneath a first end of the third horizontal member, wherein the first roller wheel set is rollably accommodated within a first channel of the workstation; and
a second roller wheel set suspended underneath a second end of the third horizontal member, wherein the second roller wheel set is rollably accommodated within a second channel of the workstation.

15. The cosmetology training manikin securing apparatus of claim 14, wherein the first channel is secured to a first frame member of the workstation and the second channel is secured to a second frame member of the workstation, wherein each of the first frame member and the second frame member of the workstation comprises a plurality of channels configured to slidably accommodate one or more of a shampoo sink, a basin, a bowl, a bucket, and an accessory tray, and wherein the workstation comprises a plurality of caster wheels attached to the first frame member and the second frame member of the workstation.
